(19) United States
(12) Patent Application Publication
(10) Pub. No.: US 2014/0090867 A1
(43) Pub. Date: Apr. 3, 2014

(54) DEVICE AND METHOD FOR ROUTING CABLES

(71) Applicant: Tyco Electronics Corporation, Berwyn, PA (US)

(72) Inventors: SEAN PATRICK KELLY, York, PA (US); Jeffrey Dean Shipe, Camp Hill, PA (US)

(73) Assignee: Tyco Electronics Corporation, Berwyn, PA (US)

(21) Appl. No.: 14/039,425

(22) Filed: Sep. 27, 2013

Related U.S. Application Data
(60) Provisional application No. 61/707,277, filed on Sep. 28, 2012.

(51) Int. Cl. H02G 3/04; H02G 1/08

(52) U.S. Cl. CPC H02G 3/0437; H02G 1/08
USPC 174/97; 29/825

(57) ABSTRACT

A cable routing device is provided for mounting and managing cables to telecommunications equipment. The cable routing device includes a support body with a plurality of cable channels defining a curved shape. A cable securing device secures the cables to the support body. The cable routing device can be mounted to the equipment after securement of the cables to the cable routing device. A variety of cable securing devices is provided including separate clips, hinged clips, and straps. Trunk cables can be mounted to the equipment, with cable breakouts extending into the equipment. The trunk cables transition from a vertical direction to a horizontal direction for entry into the equipment.

### CROSS REFERENCE TO RELATED APPLICATIONS

This application claims the benefit of U.S. Provisional Application No. 61/707,277, filed Sep. 28, 2012, and titled “DEVICE AND METHOD FOR ROUTING CABLES,” the disclosure of which is hereby incorporated herein by reference.

### FIELD OF THE INVENTION

The present invention relates to devices and methods used for routing cables into telecommunication equipment such as an enclosure, a chassis, or a panel.

### BACKGROUND OF THE INVENTION

Cable management associated with cables which are routed to and from telecommunications equipment is a significant concern. For example, ease of routing the cables to the equipment and securing the cables to the equipment during installation can be time consuming and difficult. Other concerns include minimizing the space used by the cable routing and mounting arrangement. Another concern is avoiding stresses on the cable once mounted, including pull stresses and/or torsional stresses.

### SUMMARY OF THE INVENTION

The present invention concerns a device that attaches to telecommunications equipment, such as an enclosure, at the entry point and provides a structure for holding the cables in an organized manner.

One aspect of the invention includes providing a curved support structure for managing the cables in an organized manner and accommodating a direction of entry into the equipment, such as from above the equipment, or from below the equipment.

A further aspect of the invention relates a securing feature for securing the cables to the management device to maintain the positions of the cables in an organized manner.

Various securing devices can be used to secure the cables, including clips and/or straps.

One preferred device is useable in a variety of orientations, depending on whether the cables enter the equipment from below the equipment, or from above the equipment.

A quick connect attachment mechanism allows for the device to quickly attach to the entry point of the equipment.

In one preferred method, the cables can be secured to the device before attachment to the equipment wherein the cables can be handled as a group in an organized manner once mounted to the device.

### BRIEF DESCRIPTION OF THE DRAWINGS

FIG. 1 shows a first embodiment of an enclosure including a cable routing device connected to the enclosure for managing cables extending from a vertical cable guide, and further FIG. 1 illustrates an alternative mounting position of the cable routing device;

FIG. 2 is a perspective view of the enclosure of FIG. 1;

FIG. 3 is a perspective view of one embodiment of a cable routing device including a cable securing clip;

FIG. 4 shows an alternative cable routing device, including an alternative cable securing device;

FIG. 5 shows an alternative cable securing device useable with the cable routing devices of the present invention;

FIGS. 6 and 7 show a cable routing device and a cable securing device shown in two different positions;

FIG. 8 is a perspective view of an alternative cable routing device and an alternative cable securing device;

FIG. 9 is a perspective view like FIG. 3, showing an additional cable securing clip;

FIG. 10 is a perspective view like FIG. 9, showing additional cable securing clips on an opposite side of the cable routing device.

### DETAILED DESCRIPTION OF THE PREFERRED EMBODIMENTS

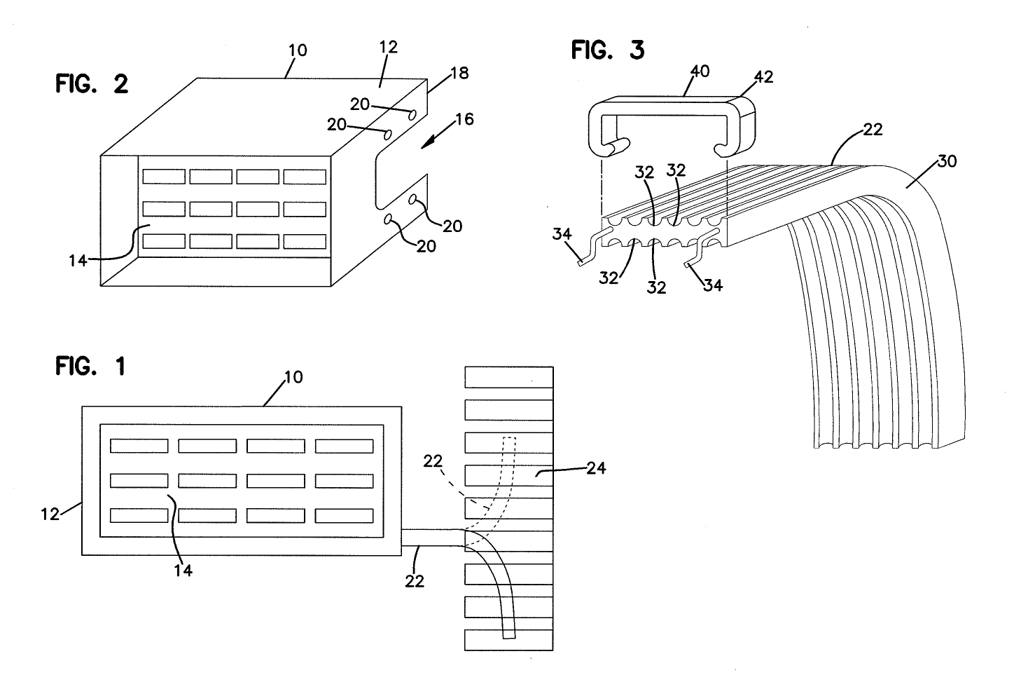

Referring now to FIGS. 1-3, an enclosure 10 is shown with a housing 12 including a patch panel 14 defining termination locations for enclosure 10. Patch panel 14 includes cable terminations, such as copper jacks or ports, or fiber optic adapters. Enclosure 10 includes a cable entry location 16. In the example shown, cable entry location 16 is adjacent to a rear 18 of enclosure 10. Cable entry location 16 defines an opening accessible from the rear for cables to enter an interior of enclosure 10 for termination on a rear side of patch panel 14. Cable entry location 16 includes a plurality of mounting holes 20 which are used to mount a cable routing device 22. Cable routing device 22 mounts to and manages the cables entering enclosure 10 at cable entry location 16.

Cable entry location 16 can be positioned in other areas on enclosure 10, as desired, including adjacent to the front. Cable routing device 22 can be used for mounting and managing front cables extending to the front of enclosure 10.

Enclosure 10 is typically rack mounted with other enclosures or equipment. Enclosure 10 has been illustrated as an enclosure with sides, a top and a bottom. Alternatively, enclosure 10 can take the form of a telecommunications chassis, panel, tray or other equipment as desired.

Typically, cables are directed to enclosure 10 from a vertical direction to a horizontal direction at cable entry location 16. Cables may be routed through a vertical cable guide 24 for managing the cables extending to and from enclosure 10.

Cable routing device 22 includes a support body 30 for supporting a plurality of cables during use. Support body 30 has a curved shape which promotes management of cables extending from a vertical direction to a horizontal direction as they enter and exit cable entry location 16 of enclosure 10. In one embodiment, support body

Support body 30 and cable channels 32 include mounting pins 34 which mount to mounting holes 20 in at least one orientation. FIG. 1 shows cable routing device 22 mountable in two positions, depending on the direction of travel of the cables extending to and from enclosure 10. As shown in FIG. 1, cable routing device 22 is shown for cables extending upwardly toward enclosure 10. The dashed lines in FIG. 1 show the alternative positioning of cable routing device 22 for cables entering from above enclosure 10.

Other structures besides mounting pins 34 can be used, such as fasteners, for connecting cable routing device 22 to enclosure 10.

Preferably, a cable securing device 40 is used with support body 30 to hold the cables in positions desired in the cable channels 32. In FIG. 3, cable securing device 40 is in the form a separate clip 42 which clips to support body 30. Preferably, cables are mounted in cable channels 32 and secured with clip 42 and then the unit is mounted to enclosure 10. Such an arrangement facilities ease of use by the user, especially in the case of cables which are numerous and/or large and/or stiff. In some cases, the weight of the cable, and coil memory in the cable would cause loose cables to become disorganized and difficult to manage. With cable routing device 22 and cable securing device 40, the cables are secured in an organized manner for handling in a single unit.

In one preferred implementation, the cables are trunk cables, and are secured outside of enclosure 10, and the smaller transition/breakout cables of the trunk cables are extended into enclosure 10, thereby saving space within enclosure 10. Further, stresses due to torsion and/or pulling of the trunk cables on the transition/breakout cables is reduced by the shape of cable routing device 22 and the securement by the cable securing device 40.

Other securing devices can include pivotally mounted clips and/or hook and loop type or other flexible straps. In some cases, a flexible strap, such as a hook and loop strap can be combined with a clip to secure the clip and/or secure additional cables.

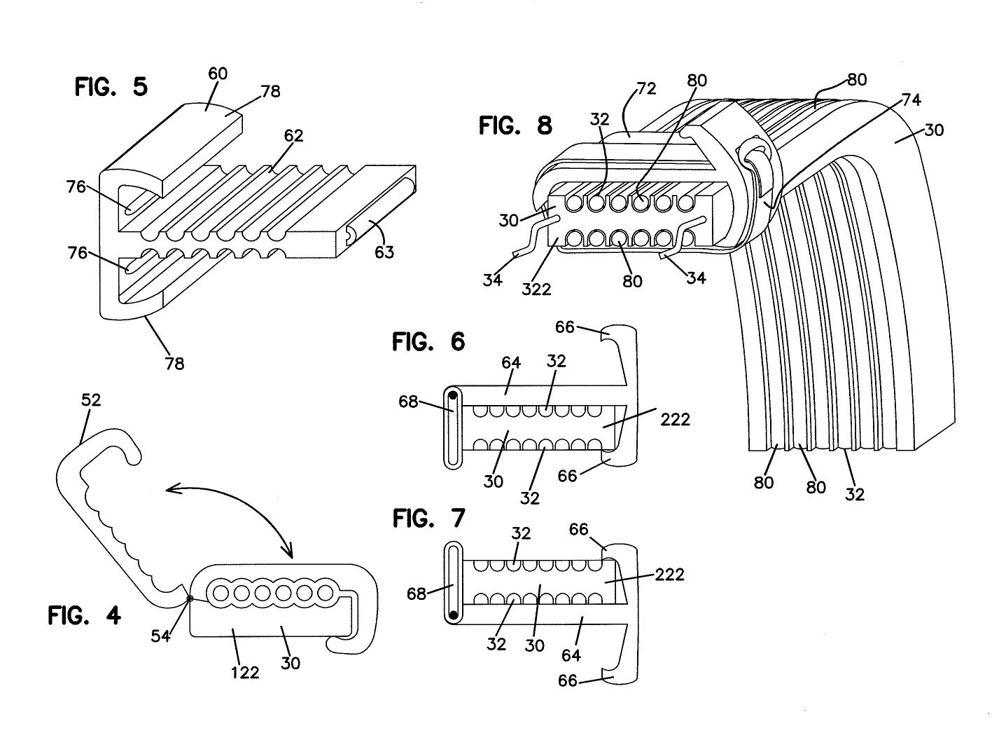

Referring now to FIG. 4, an alternative clip 52 is hinged at hinge 54 to cable routing device 122. Cable routing device 122 has a similar curved construction as cable routing device 22. Also, both cable routing device 22 of FIGS. 1-3, and cable routing device 122 of FIG. 4 have channels 32 for the cables both in the body 30 and the clip 52.

FIG. 5 shows an alternative embodiment of a cable securing device 40 including a clip 60 with a hinge 63 and two clip arms 78 which allow for the clip to be mounted in multiple positions relative to support body 30 of cable routing device 22.

Referring now to FIGS. 6 and 7, a further alternative clip 64 is hingedly mounted at hinge 68 to cable routing device 222 and is shown mountable in multiple positions with clip arms 66.

Referring now to FIG. 8, a further alternative clip 72 is mountable to cable routing device 322 in such a manner as to secure cables 80 on a top side of cable routing device 322 and a bottom side. In FIG. 8, clip 72 is shown in combination with a flexible strap 74, in the form of a hook and loop strap. Strap 74 can be positioned in openings 76 (see example in FIG. 5).

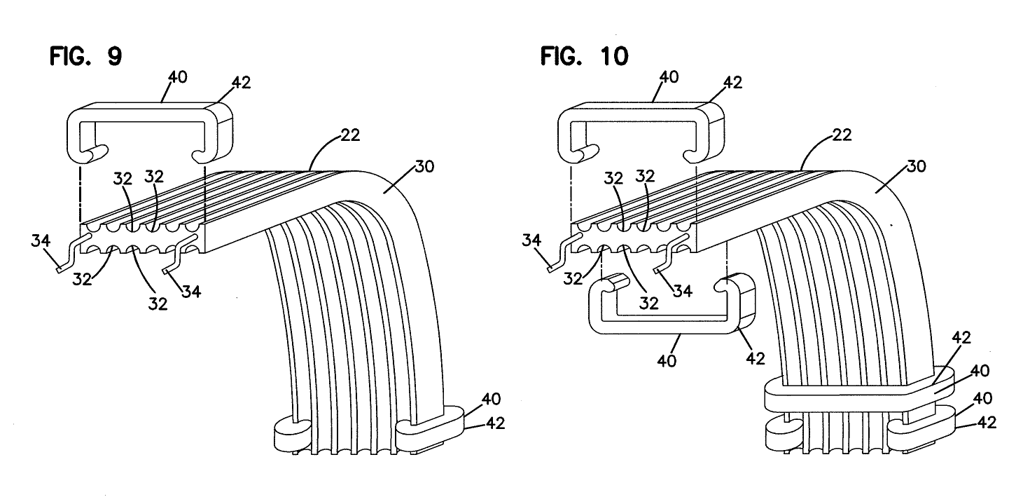

FIGS. 9 and 10 show cable routing device 22 with additional clips 42 to further hold the cables in positions desired in the cable channels 32. FIG. 9 shows two clips 42 on one side of support body 30. FIG. 10 shows two clips 42 on each side of support body 30.

Any of the disclosed clips can be made with or include materials which promote gripping. Foam can also be used to accommodate cables of different sizes. The above specification provides a complete description of the present invention. Since many embodiments of the invention can be made without departing from the spirit and scope of the invention, certain aspects of the invention reside in the claims hereinafter appended.

1. A cable routing device in comprising:
a support body defining a plurality of parallel cable channels;
wherein the support body has a curved configuration, wherein the cable channels are also curved;
a mounting device located at one end of the support body for mounting the support body to an enclosure;
a cable securing device for securing cables in the cable channels.

2. The cable routing device of claim 1, wherein the cable securing device includes a clip.

3. The cable routing device of claim 2, further comprising a plurality of clips.

4. The cable routing device of claim 2, wherein the clip is hingedly mounted to the support body.

5. The cable routing device of claim 4, wherein the clip includes a plurality of cable channels which cooperate with the cable channels of the support body to define cable passageways.

6. The cable routing device of claim 1, including a clip having at least one clip arm for clipping to the support body.

7. The cable routing device of claim 2, wherein the clip includes a flexible strap for securing additional cables to the cable routing device.

8. A cable routing system comprising:
an enclosure including a patch panel, and a side cable entry location;
a cable routing device having a support body defining a plurality of curved cable channels;
a cable securing device for securing cables to the cable routing device;
a mounting device for mounting the support body to the enclosure.

9. The system of claim 8, further comprising a vertical cable guide positioned adjacent to the enclosure, wherein the support body of the cable routing device extends into the vertical cable guide.

10. The system of claim 8, wherein the cable securing device includes a clip.

11. The system of claim 10, wherein the clip is hingedly mounted to the support body.

12. The system of claim 11, wherein the clip includes a plurality of cable channels which cooperate with the cable channels of the support body to define cable passageways.

13. The system of claim 8, including a clip having at least one clip arm for clipping to the support body.

14. The system of claim 10, wherein the clip includes a flexible strap for securing additional cables to the cable routing device.

15. The system of claim 8, wherein the cable securing device includes a plurality of clips.

16. A method of mounting cables to an enclosure comprising:
providing a cable routing device including a support body with a plurality of curved cable channels;
positioning a plurality of cables in the cable channels;
securing the cables in the cable channels with a cable securing device;
after the cables are secured to the cable routing device, mounting the cable routing device to an enclosure, wherein the cables transition from a vertical direction to a horizontal direction.

17. The method of claim 16, wherein the cables are trunk cables, and wherein cable breakouts extend into the enclosure and the trunk cables remain outside of the enclosure.
